(19) United States
(12) Patent Application Publication
(10) Pub. No.: US 2008/0261857 A1
(43) Pub. Date: Oct. 23, 2008

(54) Targeted Granulation Achieved by Neutralisation in a Compomix-Type Machine

(75) Inventors: Bernhard Orlich, Barcelona (ES); Gerhard Blasey, Dusseldorf (DE); Hans-Friedrich Kruse, Korschenbroich (DE); Keiwan Ebrahimzadeh, Dusseldorf (DE)

Correspondence Address: CONNOLLY BOVE LODGE & HUTZ LLP, PO BOX 2207, WILMINGTON, DE, 19899-2207, US

(73) Assignee: Henkel KGaA, Dusseldorf (DE)

(21) Appl. No.: 11/629,598

(22) PCT Filed: Jun. 16, 2004
(86) PCT No.: PCT/EP04/06464

§ 371 Date: Mar. 9, 2007

(51) Int. Cl. C11D 11/00

(52) U.S. Cl. 510/445

(57) ABSTRACT

Methods for manufacturing surfactant granules, which methods comprise: (a) neutralizing an anionic surfactant acid with a solid neutralization agent, wherein the anionic surfactant acid has a water content of 5 to 24 wt %, and wherein the anionic surfactant acid and the solid neutralization agent are agglomerated in a free-fall mixer, to form surfactant granules having a bulk density of 300 to 800 g/l, are described.

The present invention relates to a method for manufacturing surfactant granules. It relates in particular to a method that allows the bulk density of the surfactant granules, and the distribution of particle sizes, to be adjusted in controlled fashion.

Surfactant granules are required for the manufacture of solid washing or cleaning agents that are present, for example, as powders or compactates. Surfactant granules are manufactured, for example, by reacting anionic surfactant acids with neutralization agents. This neutralization can be carried out both with solutions of alkali-metal hydroxides and, in the context of a dry neutralization, with solid alkaline substances, in particular sodium carbonate.

In the case of neutralization with aqueous alkalis, the surfactant salts occur in the form of aqueous preparation forms, water contents in the range from approximately 10 to 80 wt %, and in particular in the range from approximately 35 to 60 wt %, being settable. Products of this kind are pasty to cuttable in nature at room temperature; the ability of such pastes to flow and be pumped already is limited or indeed becomes lost in the range of approximately 50 wt % active substance, so that considerable problems occur with further processing of such pastes, in particular with incorporation thereof into solid mixtures, for example into solid washing and cleaning agents. A long-standing need accordingly exists to make available anionic washing-agent surfactants in a dry, in particular pourable, form. It is in fact also possible using conventional drying technology, for example in a spray tower, to obtain pourable anionic surfactant powders or granules, in particular those of fatty alcohol sulfates (FAS). Serious limitations are apparent here, however, since the preparations obtained are often hygroscopic, form clumps during storage as they absorb water from the air, and also tend to clump in the final washing-agent product. Because of the necessarily high water content of pastes processed in a spray tower, the energy expenditure in such spray methods is comparatively high.

One alternative to spray-drying of surfactant pastes is represented by granulation. An extensive related art also exists in the patent literature regarding non-tower manufacture of washing and cleaning agents.

For example, European Patent Application EP-A-0 678 573 (Procter & Gamble) describes a method for manufacturing pourable surfactant granules having bulk densities above 600 g/l, in which method anionic surfactant acids are reacted with an excess of neutralization agent to yield a paste having at least 40 wt % surfactant, and this paste is mixed with one or more powder(s), at least one of which must be spray-dried and contains the anionic polymer and cationic surfactant, such that the resulting granules can optionally be dried. This document decreases the proportion of spray-dried granules in the washing and cleaning agents, but does not entirely eliminate spray-drying.

European Patent Application EP-A-0 438 320 (Unilever) discloses a method, performed in batches, for manufacturing surfactant granules having bulk densities above 650 g/l. Here a solution of an alkaline inorganic substance in water has the anionic surfactant acid added to it, possibly with the addition of other solids, and is granulated in a high-speed mixer/granulator with a liquid binder. Neutralization and granulation are performed in the same apparatus but in separate method steps, so that the method can be carried out only in individual charges.

European Patent Application EP-A-0 402 112 (Procter & Gamble) discloses a continuous neutralization/granulation method for the manufacture of FAS and/or ABS granules from the acid, in which method the ABS acid is neutralized with at least 62% NaOH and then granulated with the addition of adjuvants, for example ethoxylated alcohols or alkylphenols or a polyethylene glycol melting above 48.9° C. having a molar weight between 4000 and 50,000.

European Patent Application EP-A-0 508 543 (Procter & Gamble) recites a method in which a surfactant acid is neutralized with an excess of alkali to yield an at least 40-wt % surfactant paste that is then conditioned and granulated, direct cooling being performed with dry ice or liquid nitrogen.

Dry neutralization methods in which sulfonic acids are neutralized and granulated are disclosed in EP 555 622 (Procter & Gamble). According to the teaching of this document, neutralization of the anionic surfactant acids takes place in a high-speed mixer by way of an excess of finely particulate neutralization agent having an average particle size of less than 5 μm.

A similar method, which is likewise carried out in a high-speed mixer and in which sodium carbonate milled to 2 to 20 μm serves as a neutralization agent, is described in WO 98/20104 (Procter & Gamble).

Surfactant mixtures that are subsequently sprayed onto solid absorbents and yield washing-agent compositions or components therefor are also described in EP 265 203 (Unilever). The liquid surfactant mixtures disclosed in this document contain sodium or potassium salts of alkylbenzenesulfonic acids or alkylsulfuric acids in quantities up to 80 wt %, ethoxylated nonionic surfactants in quantities up to 80 wt %, and a maximum of 10 wt % water.

Similar surfactant mixtures are also disclosed in the earlier EP 211 493 (Unilever). According to the teaching of this document, the surfactant mixtures to be sprayed on contain between 40 and 92 wt % of a surfactant mixture, and more than 8 to a maximum of 60 wt % water. The surfactant mixture in turn is made up in turn of at least 50% polyalkoxylated nonionic surfactants and ionic surfactants.

A method for manufacturing a liquid surfactant mixture from the three constituents anionic surfactant, nonionic surfactant, and water is described in EP 507 402 (Unilever). The surfactant mixtures disclosed here, which are intended to contain little water, are manufactured by combining equimolar quantities of neutralization agent and anionic surfactant acid in the presence of nonionic surfactant.

German Application DE-A-42 32 874 (Henkel KGaA) discloses a method for manufacturing anionic surfactant granules having washing and cleaning activity by neutralizing anionic surfactants in their acid form. Solid, powdered substances are disclosed here as a neutralization agent, in particular sodium carbonate, which reacts with the anionic surfactant acids to yield anionic surfactant, carbon dioxide, and water. The resulting granules have surfactant contents of about 30 wt % and bulk densities of less than 550 g/l.

European Application EP 642 576 (Henkel KGaA) describes a two-step granulating process in two mixer/granulators connected one behind another; in a first, low-rpm granulator, 40-100 wt % (based on the total quantity of the constituents used) of the solid and liquid constituents is pregranulated, and in a second, high-rpm granulator the pregranulated material is mixed, if applicable, with the remaining constituents and converted into granules.

German Application DE-A-43 14 885 (Süd-Chemie) discloses a method for manufacturing anionic surfactant granules having washing and cleaning activity by neutralizing the acid form of anionic surfactants with an alkalizing compound, the hydrolysis-sensitive acid form of a hydrolysis-sensitive anionic surfactant being reacted with the neutralization agent with no release of water. The neutralization agent used is preferably sodium carbonate, which in this method reacts to sodium hydrogencarbonate.

The object of the present invention was to make available a continuous or discontinuous method for manufacturing surfactant granules by neutralizing anionic surfactant acids and solid neutralization agents. The bulk density of the granules to be manufactured was intended to be adjustable in controlled fashion within wide limits, and a particular goal of the present invention was to allow the low bulk densities of conventional spray-dried products also to be achievable using a non-tower method. Influencing of the particle size distribution of the granules by varying suitable factors was also intended to be possible. A controlled method procedure was also intended to make it possible, in particular, for the end products to be superior to the products that can be manufactured using methods of the existing art. The end products were thus intended to exhibit high solubility, which is a requirement, specifically in the context of use in the form of compactates, for rapid and complete dissolution of the washing- or cleaning-agent portion. An optimization of shelf life is additionally expected of the granules. Over a long period of storage, the intention was for neither adhesion of the individual granules, nor an inhomogeneous distribution of the various granule sizes in a quantity of granules, to occur as a result of a wide particle size distribution.

Particular attention was paid to cost optimization of the method according to the present invention as compared with methods described in the existing art. For example, the intention was to eliminate to the greatest possible extent method steps such as energy-intensive water evaporation or the use of energy-intensive high-speed mixers or high-shear mixers.

It has now been found that surfactant granules having a controllable bulk density and controllable granule particle size distribution can be manufactured if the reaction of the solid neutralization agents with anionic surfactant acids that have a water content from 5 to 24 wt % takes place in a free-fall mixer.

The subject matter of the present invention is a method for manufacturing surfactant granules having a bulk density from 300 to 800 g/l by neutralizing anionic surfactant acids, and if applicable further acid components, with solid neutralization agents, in which method the anionic surfactant acid(s) and the solid neutralization agent(s) are agglomerated in a free-fall mixer and if applicable subsequently processed, wherein the anionic surfactant acid has a water content of between 5 and 24 wt %.

### Anionic Surfactant Acids

In the neutralization method according to the present invention, anionic surfactant acids are reacted with solid neutralization agents. All anionic surfactant acids known to one skilled in the art are suitable, in principle, as anionic surfactant acids for this method. In preferred embodiments of the method according to the present invention, one or more substance(s) from the group of the carboxylic acids, the sulfuric acid semiesters, and the sulfonic acids, preferably from the group of the fatty acids, the fatty alkylsulfuric acids, and the alkylarylsulfonic acids, in particular from the group of the C₈₋₁₆, in particular the C₉₋₁₃ alkylbenzenesulfonic acids, is/are used as the anionic surfactant acid(s). These are described below.

In order to exhibit adequate surface-active properties, the aforesaid compounds should possess longer-chain hydrocarbon radicals, i.e. should have at least 6 C atoms in the alkyl or alkenyl radical. The C-chain distributions of the anionic surfactants are usually in the range from 6 to 40, preferably 8 to 30, and in particular 12 to 22 carbon atoms.

Carboxylic acids that are utilized in the form of their alkali-metal salts as soaps in washing and cleaning agents are obtained industrially, for the most part, by hydrolysis from natural fats and oils. While alkaline saponification, already carried out in the last century, resulted directly in the alkali salts (soaps), today what is used on an industrial scale for cleavage is only water, which cleaves the fats into glycerol and the free fatty acids. Methods applied industrially are, for example, cleavage in autoclaves or continuous high-pressure cleavage. Carboxylic acids usable in the context of the present invention as an anionic surfactant are, for example, hexanoic acid (caproic acid), heptanoic acid (oenanthic acid), octanoic acid (caprylic acid), nonanoic acid (pelargonic acid), decanoic acid (capric acid), undecanoic acid, etc. It is preferred in the context of the present invention to use fatty acids such as dodecanoic acid (lauric acid), tetradecanoic acid (myristic acid), hexadecanoic acid (palmitic acid), octadecanoic acid (stearic acid), eicosanoic acid (arachidic acid), docosanoic acid (behenic acid), tetracosanoic acid (lignoceric acid), hexacosanoic acid (cerotinic acid), triacontanoic acid (melissic acid), and the unsaturated species 9c-hexadecenoic acid (palmitoleic acid), 6c-octadecenoic acid (petroselinic acid), 6t-octadecenoic acid (petroselaidic acid), 9c-octadecenoic acid (oleic acid), 9t-octadecenoic acid (elaidic acid), 9c,12c-octadecadienoic acid (linoleic acid), 9t,12t-octadecadienoic acid (linolaidic acid), and 9c,12c,15c-octadecatrienoic acid (linolenic acid). For cost reasons, it is preferred to use not the pure species but instead technical mixtures of the individual acids that are accessible via fat cleavage. Such mixtures are, for example, coconut oil fatty acid (approx. 6 wt % C₈, 6 wt % C₁₀, 48 wt % C₁₂, 18 wt % C₁₄, 10 wt % C₁₆, 2 wt % C₁₈, 8 wt % C_{18′}, 1 wt % C_{18″}), palm oil fatty acid (approx. 4 wt % C₈, 5 wt % C₁₀, 50 wt % C₁₂, 15 wt % C₁₄, 7 wt % C₁₆, 2 wt % C₁₈, 15 wt % C_{18′}, 1 wt % C_{18″}), tallow fatty acid (approx. 3 wt % C₁₄, 26 wt % C₁₆, 2 wt % C_{16′}, 2 wt % C₁₇, 17 wt % C₁₈, 44 wt % C_{18′}, 3 wt % C_{18″}, 1 wt % C_{18′″}), hardened tallow fatty acid (approx. 2 wt % C₁₄, 28 wt % C₁₆, 2 wt % C₁₇, 63 wt % C₁₈, 1 wt % C_{18′}), technical oleic acid (approx. 1 wt % C₁₂, 3 wt % C₁₄, 5 wt % C₁₆, 6 wt % C_{16′}, 1 wt % C₁₇, 2 wt % C₁₈, 70 wt % C_{18′}, 10 wt % C_{18″}, 0.5 wt % C_{18′″}), technical palmitic/stearic acid (approx. 1 wt % C₁₂, 2 wt % C₁₄, 45 wt % C₁₆, 2 wt % C₁₇, 47 wt % C₁₈, 1 wt % C_{18′}), and soybean oil fatty acid (approx. 2 wt % C₁₄, 15 wt % C₁₆, 5 wt % C₁₈, 25 wt % C_{18′}, 45 wt % C_{18″}, 7 wt % C_{18′″}).

Sulfuric acid semiesters of longer-chain alcohols are likewise anionic surfactants in their acid form, and are usable in the context of the method according to the present invention. Their alkali-metal, in particular sodium, salts, the fatty alcohol sulfates, are accessible industrially from fatty alcohols, which are reacted with sulfuric acid, chlorosulfonic acid, amidosulfonic acid, or sulfur trioxide to yield the relevant alkylsulfuric acids, and then neutralized. The fatty alcohols are obtained from the relevant fatty acids or fatty acid mixtures by high-pressure hydrogenation of the fatty acid methyl esters. The most important industrial process, in terms of volume, for manufacturing fatty alkylsulfuric acids is sulfonation of the alcohols with SO₃/air mixtures in special cascade, falling-film, or tube-bundle reactors.

A further class of anionic surfactant acids that can be used in the method according to the present invention are the alkyl ethersulfuric acids, whose salts (the alkyl ethersulfates) are notable by comparison with the alkyl sulfates for a higher water solubility and lower sensitivity to water hardness (solubility of calcium salts). Alkyl ethersulfuric acids are synthesized, like the alkylsulfuric acids, from fatty alcohols that are reacted with ethylene oxide to yield the relevant fatty alcohol ethoxylates. Propylene oxide can also be used instead of ethylene oxide. Subsequent sulfonation with gaseous sulfur trioxide in short-duration sulfonation reactors produces the relevant alkyl ethersulfuric acids at yields exceeding 98%.

Alkanesulfonic acids and olefinsulfonic acids are also usable in the context of the present invention as anionic surfactants in acid form. Alkanesulfonic acids can contain the sulfonic acid group in terminally bonded fashion (primary alkanesulfonic acids) or along the carbon chain (secondary alkanesulfonic acids); only the secondary alkanesulfonic acids are of commercial significance. These are produced by sulfochlorination or sulfoxidation of linear hydrocarbons. In sulfochlorination according to Reed, n-alkanes are reacted with sulfur dioxide and chlorine under UV light irradiation to produce the corresponding sulfochlorides, which directly yield the alkanesulfonates upon hydrolysis with alkalis, and the alkanesulfonic acids upon reaction with water. Because di- and polysulfochlorides as well as chlorinated hydrocarbons can occur during sulfochlorination as byproducts of the radical reaction, the reaction is usually performed only up to conversion rates of 30% and then halted.

Another process for manufacturing alkanesulfonic acids is sulfoxidation, in which n-alkanes are reacted with sulfur dioxide and oxygen under UV light irradiation. This radical reaction produces successive alkylsulfonyl radicals that react further with oxygen to yield the alkylpersulfonyl radicals. The reaction with unconverted alkane yields an alkyl radical and the alkylpersulfonic acid, which decomposes into an alkylperoxysulfonyl radical and a hydroxyl radical. The reaction of the two radicals with unconverted alkane produces the alkylsulfonic acids and water, which reacts with alkylpersulfonic acid and sulfur dioxide to produce sulfuric acid. To maximize the yield of the two end products (alkylsulfonic acid and sulfuric acid) and to suppress secondary reactions, this reaction is usually performed only up to conversion rates of 1% and then halted.

Olefinsulfonates are produced industrially by reacting α-olefins with sulfur trioxide. This forms intermediary zwitterions that cyclize into so-called sultones. Under suitable conditions (alkaline or acid hydrolysis), these sultones react to form hydroxylalkanesulfonic acids or alkanesulfonic acids, both of which can likewise be used as anionic surfactant acids.

Alkylbenzenesulfonates have been known as high-performance anionic surfactants since the 1930s. At that time alkylbenzenes were produced by monochlorination of Kogasin fractions and subsequent Friedel-Crafts alkylation, and then sulfonated with oleum and neutralized with sodium hydroxide. In the early 1950s, alkylbenzenesulfonates were produced by tetramerizing propylene to form branched α-dodecylene, and the product was converted via a Friedel-Crafts reaction, using aluminum trichloride or hydrogen fluoride, to tetrapropylenebenzene, which was then sulfonated and neutralized. This capability of economically producing tetrapropylenebenzenesulfonates (TPS) resulted in a breakthrough for this class of surfactants, which subsequently displaced the soaps as the principal surfactant in washing and cleaning agents.

The insufficient biodegradability of TPS made it necessary to present new alkylbenzenesulfonates characterized by improved environmental behavior. These requirements are met by linear alkylbenzenesulfonates, which today are almost the only alkylbenzenesulfonates manufactured, and are referred to by the abbreviation ABS.

Linear alkylbenzenesulfonates are manufactured from linear alkylbenzenes, which in turn are accessible from linear olefins. For this, petroleum fractions are separated on an industrial scale, using molecular sieves, into the n-alkanes of the desired purity, and dehydrogenated to yield the n-olefins, resulting in both α- and i-olefins. The resulting olefins are then reacted with benzene in the presence of acid catalysts to yield the alkylbenzenes. The Friedel-Crafts catalyst that is selected has an influence on the isomer distribution of the resulting linear alkylbenzenes: when aluminum trichloride is used, the concentration of the 2-phenyl isomers in the mixture with the 3-, 4-, 5-, and other isomers is approximately 30 wt %; when hydrogen fluoride is used as the catalyst, on the other hand, the concentration of the 2-phenyl isomer can be decreased to approximately 20 wt %. Lastly, sulfonation of the linear alkylbenzenes is today performed on an industrial scale using oleum, sulfuric acid, or gaseous sulfur trioxide, the latter being by far the most important. Special film or tube-bundle reactors are used for sulfonation, supplying as their product a 97-wt % alkylbenzenesulfonic acid (ABSA) that is usable in the context of the present invention as an anionic surfactant acid.

A very wide variety of salts, i.e. alkylbenzenesulfonates, can be obtained from ABSAs by selecting the neutralizing medium. For economic reasons, it is preferred in this context to manufacture and use the alkali-metal salts, and of them preferably the sodium salts, of the ABSAs. These can be described by the general formula I:

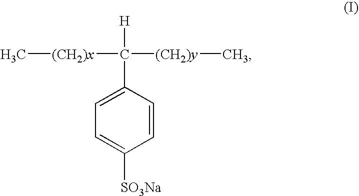

in which the sum of x and y is usually between 5 and 13. Methods according to the present invention in which C₈₋₁₆, preferably C₉₋₁₃, alkylbenzenesulfonic acids are used as the anionic surfactant in acid form are preferred. It is further preferred in the context of the present invention to use C₈₋₁₆, preferably C₉₋₁₃, alkylbenzenesulfonic acids that derive from alkylbenzenes which have a tetraline content below 5 wt % based on the alkylbenzene. It is additionally preferred to use alkylbenzenesulfonic acids whose alkylbenzenes were produced using the HF method, so that the C₈₋₁₆, preferably C₉₋₁₃, alkylbenzenesulfonic acids used have a 2-phenyl isomer content below 22 wt % based on the alkylbenzenesulfonic acid.

The aforementioned anionic surfactants in their acid form can be used in the method according to the present invention alone or mixed with one another. It is also possible and preferred, however, for the anionic surfactant in acid form to have mixed into it, prior to addition to the solid neutralization agent(s), further, preferably acid, ingredients of washing and cleaning agents in quantities from 0.1 to 40 wt %, preferably 1 to 15 wt %, and in particular 2 to 10 wt %, based in each case on the weight of the anionic surfactant acid-containing mixture.

Suitable as acid reaction partners in the context of the present invention, in addition to the “surfactant acids,” are also the aforesaid fatty acids, phosphonic acids, polymeric acids, or partially neutralized polymeric acids, as well as “builder acids” and “complex builder acids,” alone or in any mixtures. Especially good choices as ingredients of washing and cleaning agents that can be mixed into the anionic surfactant acid are acid washing and cleaning agent ingredients, i.e. for example phosphonic acids, which in neutralized form (phosphonates) are a constituent of many washing and cleaning agents as incrustation inhibitors. The use of (partially neutralized) polymeric acids such as, for example, polyacrylic acid is also possible. It is, however, also possible to mix acid-stable ingredients with the anionic surfactant acid. Suitable here, for example, are so-called minor components that otherwise would need to be added in complex additional steps, i.e. for example optical brighteners, dyes, etc.; acid stability must be checked in each individual case.

It is preferred to mix into the anionic surfactant in acid form nonionic surfactants in quantities from 0.1 to 40 wt %, preferably 1 to 15 wt %, and in particular 2 to 10 wt %, based in each case on the weight of the anionic surfactant acid-containing mixture. This addition can improve the physical properties of the anionic surfactant acid-containing mixture, and render superfluous any later incorporation of nonionic surfactants into the surfactant granules or into the entire washing or cleaning agent. The various representatives of the group of nonionic surfactants are described below.

The anionic surfactant acids reacted in the method according to the present invention have a water content of between 5 and 24 wt %. A water content of 6 to 22 wt %, in particular between 7 and 20 wt %, is particularly preferred.

According to the present invention, anionic surfactant acids that contain 5 to 24 wt % water are used in the method described. On the other hand, in this method preferably less than 5 wt % water, based on the neutralization agent, is introduced into the mixer by way of the neutralization agent. A water content in the neutralization agent of less than 4 wt %, in particular less than 3 wt %, is particularly preferred. In a particularly preferred embodiment of the method, the neutralization agent contains 1-2 wt % water.

A method of this kind differs from typical methods of the existing art in which water gets into the reaction mixture because of the use of water-containing neutralization agents, such as aqueous neutralization-agent pastes or aqueous solutions of neutralization agents. In these methods, the input of water into the mixture resulting from the use of the anionic surfactant acids is not intentional. It cannot be completely prevented, however, since for technical reasons anionic surfactant acids contain up to 3 wt % water.

As discussed above, both bulk densities and the particle size distribution of the method products can be adjusted in controlled fashion by means of the method according to the present invention.

In a preferred embodiment of the method according to the present invention, the anionic surfactant acid contains 5-17 wt % water. Preferred with regard to this embodiment are water contents of the acid that are between 6 and 16 wt %, particularly preferably between 7 and 15 wt %, and in particular between 8 and 14 wt %. A form of the method in which the water content of the anionic surfactant acid is between 9 and 13 wt %, and in particular between 10 and 12 wt %, is very particularly preferred.

If the water content of the anionic surfactant acid is selected from the range between 5 and 17 wt % described in the previous section, granules having low bulk densities are obtained after neutralization and granulation. The bulk densities are preferably 300-600 g/l, particularly preferably 400-600 g/l, in particular 500-600 g/l. The proportion of surfactant granules having a particle size between 100 and 800 μm before processing is, in this preferred embodiment of the method, at least 40 wt %, preferably at least 47 wt %, particularly preferably at least 55 wt %, very particularly preferably at least 60 wt %, and in particular at least 70 wt %.

The proportion of coarse-particle granules having particle sizes between 800 and 1600 μm before processing is preferably more than 20 wt %, particularly preferably more than 25 wt %, in particular more than 30 wt %. The proportion of fine-particle granules having particle sizes between 100 and 200 μm is, on the other hand, preferably less than 17 wt %, particularly preferably less than 14 wt %, in particular between 1 and 12 wt %.

A preferred subject of the invention is a method for manufacturing surfactant granules having a bulk density from 300 to 600 g/l by neutralizing anionic surfactant acids, and if applicable further acid components, with solid neutralization agents, in which method the anionic surfactant acid(s) and the solid neutralization agent(s) are agglomerated in a free-fall mixer and if applicable subsequently processed, wherein the anionic surfactant acid has a water content of between 5 and 17 wt %.

In a further preferred embodiment of the method according to the present invention, the anionic surfactant acid contains 10-24 wt % water. Preferred with regard to this embodiment are water contents of the acid that are between 11 and 23 wt %, particularly preferably between 12 and 22 wt %, and in particular between 13 and 21 wt %. A form of the method according to the present invention in which the water content of the anionic surfactant acid is between 14 and 20 wt %, and in particular between 15 and 19 wt %, is very particularly preferred.

If the water content of the anionic surfactant acid is selected from the range between 10 and 24 wt % described in the previous section, granules having moderate bulk densities are obtained after neutralization and granulation. The bulk densities are preferably 500-800 g/l, particularly preferably 500-700 g/l, in particular 500-600 g/l. The proportion of surfactant granules having a particle size between 100 and 800 μm before processing is, in this preferred embodiment of the method, at least 52 wt %, preferably at least 62 wt %, particularly preferably at least 70 wt %, very particularly preferably at least 76%, and in particular at least 80 wt %.

In this preferred method, the proportion of coarse-particle granules having particle sizes between 800 and 1600 μm before processing is preferably less than 20 wt %, particularly preferably less than 15 wt %, in particular between 1 and 10 wt %. The proportion of fine-particle granules having particle sizes between 100 and 200 μm is, on the other hand, preferably greater than 17 wt %, particularly preferably greater than 23 wt %, in particular greater than 27 wt %.

A preferred subject of the invention is a method for manufacturing surfactant granules having a bulk density from 500 to 800 g/l by neutralizing anionic surfactant acids, and if applicable further acid components, with solid neutralization agents, in which method the anionic surfactant acid(s) and the solid neutralization agent(s) are agglomerated in a free-fall mixer and if applicable subsequently processed, wherein the anionic surfactant acid has a water content of between 10 and 24 wt %.

The neutralized form of the anionic surfactant acids (called simply “anionic surfactants”) can be contained in varying quantities in the agents manufactured in accordance with the method according to the present invention. Preferred methods according to the present invention are characterized in that the neutralized anionic surfactant acid content of the method products is a maximum of 80 wt %, preferably 8 to 72 wt %, particularly preferably 10 to 65 wt %, and in particular 15 to 55 wt %.

The method according to the present invention is therefore suitable for the manufacture of surfactant-rich granules having a surfactant content greater than 40 wt %, and also for the manufacture of comparatively surfactant-poor granules.

The surfactant-rich method products preferably contain neutralized anionic surfactant acids in weight proportions from 40 to 80 wt %, preferably 45 to 75 wt %, particularly preferably 50 to 72 wt %, and in particular 60 to 70 wt %. These method products are preferably used in washing- and cleaning-agent concentrates.

In a further preferred embodiment of the method according to the present invention, surfactant-poor method products are obtained in which neutralized anionic surfactant acids are contained in weight proportions of a maximum of 50 wt %, preferably between 8 and 42 wt %, particularly preferably between 10 and 35 wt %, and in particular between 20 and 30 wt %. These method products are preferably used in the manufacture of high-volume standard washing and cleaning agents.

### Neutralization Agents

All neutralization agents known to one skilled in the art are suitable, in principle, as solid neutralization agents for this method. In preferred embodiments of the method according to the present invention, one or more substances of the compounds sodium carbonate, sodium hydroxide, sodium sesquicarbonate, potassium hydroxide, and/or potassium carbonate are used as neutralization agents.

Alternatively or as a supplement to the combination of different solid neutralization agents, components not participating in the reaction, in particular carrier materials, can also be added to the neutralization agent. These should then exhibit sufficient stability, with respect to the acids that are added, to avoid local decomposition and thus undesired discoloration of or other impact on the product. Methods in which further solids from the groups of the silicates, aluminum silicates, citrates, and/or phosphate are used are preferred here. It is particularly preferred for sodium sulfate, which even today is contained at up to 45 wt % in washing agents in some countries, to be mixed into the solid neutralization agent(s).

The weight ratio of the solid neutralization agent(s), including possible additions, used in the method according to the present invention to the anionic surfactant acid(s), as well as optionally other acid components, that are used, can vary within wide limits.

Preferred here are methods according to the present invention in which the weight ratio of the solid neutralization agent(s) used in the method according to the present invention to the anionic surfactant acid(s), as well as optionally other acid components, that are used, is between 100:1 and 1:5, preferably between 80:1 and 1:4, by preference between 60:1 and 1:3, very particularly preferably between 40:1 and 1:2, and in particular between 20:1 and 1:1.

The neutralization agent to be used preferably contains less than 5 wt % free water. A water content of less than 4 wt %, in particular less than 3 wt %, is particularly preferred. In a particularly preferred embodiment of the method, the neutralization agent contains less than 2 wt % free water. It is particularly preferred to use neutralization agents that have a concentration of free water, i.e. water not present in the form of water of hydration and/or water of constitution, below 1 wt %, preferably below 0.5 wt %, and that in particular have no free water.

The neutralization agent described in the section above is mixed in a free-fall mixer with anionic surfactant acid containing 5 to 24 wt % water. The shelf life and dissolution behavior and the bulk density of the granules, and the distribution of particle sizes, is influenced by the selection of the weight ratio between neutralization agent and water. In a preferred embodiment of the method according to the present invention, the weight ratio between the solid neutralization agent that is used and the water brought in with the anionic surfactant acid is between 800:1 and 2:3. A ratio of the weight proportions between 199:1 and 1:1, in particular between 99:1 and 15:7, is preferred. In a particularly preferred embodiment of the method the ratio of the weight proportions of neutralization agent and water is between 19:1 and 19:6.

The water content of the end products of the method, determined by loss on drying at 120° C., is preferably less than 26 wt %, by preference 1-15 wt %, particularly preferably 1-10 wt %, and in particular 4-5 wt %.

Water occurs naturally in the context of the neutralization reaction. In order to ensure method products having a total water content of less than 26 wt %, a method procedure should be selected in which principally sodium hydrogencarbonate, rather than water and CO₂, is formed. This method procedure is described below.

### Free-Fall Mixer

The use of free-fall mixers to carry out the neutralization of anionic surfactant acids with solid neutralization agents is characteristic of the method according to the present invention. The free-fall mixers can be operated continuously or discontinuously.

“Free-fall mixers” refers, in the context of the present invention, to those mixers in which the mixed material is lifted up by friction with the walls and then falls freely through the mixer space under its own weight. Free-fall mixers of this kind have a movable or rotating reactor housing, or a moving mixing vessel. Suitable vessels are those having simple geometric shaped (cylinder, single or double cone, cube, and the like). Preferred mixing vessels furthermore have inner corners with angles that are as obtuse as possible, since this facilitates both free motion of the mixed material and emptying and cleaning of the vessel once the method is finished. The motion of the vessel must be transferred to the mixed material in the interior in such a way that the reaction mixture is thrown together and broken apart as irregularly as possible.

In a preferred embodiment of the method according to the present invention, the solid neutralization agent moving in the free-fall mixer forms a falling powder curtain onto which the anionic surfactant acids are sprayed.

Suitable types of motion for the free-fall mixer are, in particular, rotation about a vessel axis (drum or rotating-tube mixer) or about axes that do not coincide with geometric axes of the vessel or are perpendicular to its planes of symmetry (drum mixers), or vibration, preferably at high amplitude and low frequency and with alternating deflection directions, so that irregularly shaking or tumbling motions occur.

In a preferred method, a directed motion component must occur in order to ensure continuous material transport and thus make possible a continuous method. A discontinuous method is preferred to the same degree, a directed motion component not being desired.

In particular, those free-fall mixers that rotate about their horizontal axis, preferably about their slightly inclined axis, are particularly suitable for continuous operation. As a result of the inclination of the rotation axis, the mixed material exhibits a directional motion because of its own weight, which motion makes possible a continuous discharge of mixed material from the mixer. A directional motion of this kind can of course be generated not only by the inclination of the rotation axis but also by a continuous input of anionic surfactant acids and solid neutralization agent. It has proven to be advantageous for the product properties, in particular for adjusting the bulk density and the solubility of the reaction products, if the angle of inclination of the rotation axis of a rotatable vessel that is preferably used correlates with a specific rotation speed. Those methods according to the present invention in which the rotatable vessel of the free-fall mixer has an angle of inclination α from 0 to 20°, in particular from 0 to 15°, very particularly preferably from 1 to 15°, and the motion of the rotatable vessel of the free-fall mixer is simultaneously adjusted by way of the drive system to 20 to 70 revolutions per minute and in particular to 30 to 60 revolutions per minute, are therefore particularly preferred.

Free-fall mixers that are preferred in the context of the present invention are drum mixers, tumble mixers, cone mixers, double-cone mixers, or V mixers. The free-fall mixers used according to the present invention present to the material being lifted up and then falling down in the interior, in the context of rotating or tumbling motions, alternatingly inclined walls and therefore a deflection, expansion, or contraction of the space, and displacement and division of the flow of material. Reactors of this kind can furthermore comprise static and/or moving mixing and/or cutting tools. Rotating reactors in which the mixed material is lifted up by friction with the walls, and then falls freely through the mixing space under its own weight, are nevertheless preferred.

Particularly preferred are methods according to the present invention in which double-cone mixers having a rotatable vessel without mixing tools are used as free-fall mixers, the continuously operated double-cone mixers being subdivided into a mixing zone and a post-mixing zone, and comprising a knock-off bar that is mounted on an end plate and from there passes through the entire mixing zone and, if applicable, extends into the post-mixing zone. In the double-cone mixers that are used with particular preference, the ratio of the length of the mixing zone to the length of the post-mixing zone is preferably at least 1:1.

The knock-off bar can have a width from 50 to 150 mm, preferably from 75 to 130 mm. The upper edge of the knock-off bar is at a distance from the inner mixer wall that constitutes preferably a maximum of 10% of the drum diameter of the narrowest point of the rotatable vessel, preferably a maximum of 5% of the narrowest point of the rotatable vessel, and in particular less than 2.5% of the narrowest point of the rotatable vessel. In the post-mixing zone, the spacing from the closest inner mixer wall can certainly be larger than in the mixing zone; values between 100 and 300 mm are entirely usual.

In preferred embodiments of the present method according to the present invention, the residence time of the reaction mixture in the free-fall mixer is preferably less than 20 minutes, by preference between 1 and 600 seconds, particularly preferably between 1 and 300 seconds, and in particular between 1 and 120 seconds.

Regardless of whether a single anionic surfactant acid or several anionic surfactant acids—optionally mixed with further acid or acid-stable ingredients—is or are applied onto the solid neutralization agent or the mixture of several solids, it is preferred that the temperature of the mixture to be applied be as low as possible. Methods according to the present invention in which the liquid acid component has a temperature, upon entry into the free-fall mixer, from 20 to 60° C., preferably 30 to 55° C., and in particular 40 to 50° C., are preferred here.

If sodium carbonate is used as a neutralization agent in a preferred method, it is possible in particular, by complying with these temperature stipulations in the context of a given ratio of anionic surfactant acid to sodium carbonate, to control proportion of the sodium hydrogencarbonate in the method products. In this context, “liquid, acid component” refers to the anionic surfactant acid, which encompasses water and, if applicable, further acid components.

When a preferred method according to the present invention is carried out, the reaction between anionic surfactant acid(s) and sodium carbonate is managed in such a way that the reaction

Na₂CO₃+2 anionic surfactant-H →2 anionic surfactant-Na+CO₂+H₂O

is largely suppressed, and the reaction

Na₂CO₃+anionic surfactant-H →anionic surfactant-Na+NaHCO₃

occurs instead.

The sodium carbonate is used here in excess, so that unreacted sodium carbonate remains in the product, while sodium hydrogencarbonate additionally occurs in the reaction. The quantity of sodium carbonate in the agent (based on the agent, with no consideration of water-of-hydration contents that may be present) is correlated with the quantity of sodium hydrogencarbonate in the agent (based on the agent, with no consideration of water-of-hydration contents that may be present).

In preferred embodiments of the present invention, the mass ratio of sodium carbonate to sodium hydrogencarbonate is within narrower limits; in methods preferred according to the present invention, the weight ratio of sodium carbonate to sodium hydrogencarbonate in the end products of the method is 50:1 to 5:1, preferably 40:1 to 5.1:1, particularly preferably 35:1 to 5.2:1, and in particular 30:1 to 5.25:1.

A further possibility for promoting the formation of sodium hydrogencarbonate and avoiding the formation of carbon dioxide and water involves keeping temperatures as low as possible. This can be achieved, for example, by cooling, but also by way of a suitable method procedure or by coordinating the quantities of reactants. Methods according to the present invention in which the temperature during the method is kept below 100° C., preferably below 80° C., particularly preferably below 60° C., and in particular below 50° C., are preferred here.

The sodium hydrogencarbonate content of the end products of the method can vary as a function of the quantities of sodium carbonate and anionic surfactant acid(s) that are used. In preferred methods according to the present invention, the sodium hydrogencarbonate content of the end products of the method is 0.01 to 20 wt %, preferably 0.1 to 15 wt %, particularly preferably 0.5 to 10 wt %, and in particular 1 to 10 wt %, based in each case on the total weight of the end products of the method. In a particularly preferred embodiment of the method according to the present invention, the sodium hydrogencarbonate content of the end products of the method is between 2 and 10 wt %, preferably between 2.5 and 10 wt %, particularly preferably between 3 and 10 wt %, and in particular between 4 and 10 wt %.

### Post-Processing

After the mixing operation ends, the granules can be post-processed as required. For that purpose, in the case of a continuous method the surfactant granules, after passing through the post-mixing zone, are either discharged directly via the discharge, or transported on via a conveying apparatus.

As in the case of a continuous mixing operation, when a batch method is used it is possible to carry out post-processing of the surfactant granules continuously or discontinuously. It is particularly preferred in this context for a mixing method effected in batches to be followed once again by a batch-based post-processing that allows the surfactants granules to remain in the original reactor.

The term “post-processing” encompasses, in the context of the present Application, in particular spray granulation, i.e. the further addition of liquid binding agents, encapsulation, dusting with surface modifiers, application of nonionic surfactants, drying or spray drying, cooling, and the separation of coarse and/or fine portions.

As dusting agents or surface modifiers, all known, finely particulate representatives of this group can be added by way of a delivery of solids. Preferred in this context are amorphous and/or crystalline aluminum silicates such as zeolite A, X, and/or P, various types of silicic acids, calcium stearate, carbonates, sulfates, but also finely particulate compounds made up, for example, of amorphous silicates and carbonates.

The nonionic surfactants used are preferably alkoxylated, advantageously ethoxylated, in particular primary alcohols having preferably 8 to 18 C atoms and an average of 1 to 12 mol ethylene oxide per mol of alcohol, alkyl glycosides of the general formula RO(G)ₓ, alkoxylated, preferably ethoxylated or ethoxylated and propoxylated fatty acid alkyl esters, preferably having 1 to 4 carbon atoms in the alkyl chain, amine oxides, and polyhydroxy fatty acid amides.

Hot air is preferably used for drying. Cooling is preferably accomplished with cold air or dry ice.

Coarse and/or fine portions that are separated out are preferably conveyed back into the process, the coarse portion preferably being milled before being introduced back into the free-fall mixer.

Post-processing also in turn includes, of course, the “curing” of a product, i.e. for example termination of the chemical reaction in the context of the execution of neutralization reactions. In a preferred variant of the method according to the present invention, the post-processing encompasses a spray granulation and/or an encapsulation and/or a dusting with surface modifiers and/or an application of nonionic surfactants and/or a drying and/or a spray drying onto inert bodies and/or a cooling and/or a separation of coarse and/or fine portions.

Post-processing of the method products after discharge from the free-fall mixer onto a reaction section is a characteristic of particularly preferred embodiments of the present method according to the present invention, those method variants in which the reaction section is a pneumatic fluidized bed and/or a transport belt and/or a mixer being very particularly preferred. If this conveying and metering screw leads into the post-mixing zone (a direct connection of the conveying apparatus to the discharge unit is also possible), it is preferred that the screw protrude at most only into the second longitudinal half of the post-mixing zone, and therefore not into the part of the post-mixing zone that still contains the knock-off bar.

The residence time in the post-mixing zone is preferably between 1 and 19 minutes, by preference between 2 and 17 minutes, very particularly preferably between 3 and 14 minutes, in particular between 3 and 10 minutes.

### Bulk Densities and Particle Sizes

The agents manufactured in accordance with the method according to the present invention can have different bulk densities depending on the concentration of the individual ingredients, in particular water, and on other method parameters. Embodiments of the method according to the present invention in which the bulk density of the end products of the method is 300 to 800 g/l, preferably 350 to 700 g/l, particularly preferably 400 to 650 g/l, and in particular 500 to 600 g/l are preferred.

As compared with the granules described in the prior art, the granules obtained have an elevated solubility in water and aqueous solutions as well as a greater shelf life. Neither adhesion of individual granules, nor demixing of a quantity of granules after movement (tilting or shaking) of the storage vessel, have been observed.

These method products furthermore have a particle size distribution with an average particle size d₅₀ below 5000 μm, preferably between 20 and 3000 μm, particularly preferably between 40 and 2000 μm, and in particular between 50 and 1600 μm.

The surfactant granules having a particle size between 100 and 1600 μm preferably have, before processing, a weight proportion of at least 80 wt %, preferably at least 82 wt %, particularly preferably at least 85 wt %, very particularly preferably at least 90 wt %, and in particular at least 95 wt %. Surfactant granules that have, before processing, a particle size between 100 and 800 μm are contained in the methods according to the present invention in weight proportions of at least 52 wt %, preferably at least 62 wt %, particularly preferably at least 70 wt %, very particularly preferably at least 76 wt %, and in particular at least 80 wt %.

### Further Ingredients

The surfactant granules manufactured in accordance with the method according to the present invention are suitable in particular for the manufacture of washing or cleaning agents, in particular solid washing or cleaning agents, for example by further agglomeration, by extrusion or by compacting. Washing or cleaning agents of this kind contain, in addition to the ingredients previously recited such as the anionic surfactant acids, further constituents, in particular from the group of the builders, co-builders, bleaching agents, bleach activators, dyes and fragrances, optical brighteners, enzymes, soil-release polymers, and so forth. These substances are described below for the sake of completeness.

### Detergency Builders

Detergency builders are used in washing or cleaning agents principally in order to bind calcium and magnesium. Usual builders, which are added in the context of the invention preferably in quantities from 22.5 to 45 wt %, preferably 25 to 40 wt %, and in particular 27.5 to 35 wt %, based in each case on the entire agent that also contains the end products of the method according to the present invention, are the low-molecular-weight polycarboxylic acids and their salts, the homopolymeric and copolymeric polycarboxylic acids and their salts, the carbonates, phosphates, and sodium and potassium silicates. Trisodium citrate and/or pentasodium tripolyphosphate, and silicate builders from the class of the alkali disilicates, are preferably used for washing or cleaning agents. Among the alkali-metal salts, the potassium salts are generally to be preferred to the sodium salts, since they often possess higher water solubility. Preferred water-soluble detergency builders are, for example, tripotassium citrate, potassium carbonate, and the potassium water glasses.

Usable organic builder substances are, for example, the polycarboxylic acids usable in the form of their sodium salts, “polycarboxylic acids” being understood as those carboxylic acids that carry more than one acid function. These are, for example, citric acid, adipic acid, succinic acid, glutaric acid, malic acid, tartaric acid, maleic acid, fumaric acid, sugar acids, aminocarboxylic acids, nitrilotriacetic acid (NTA), provided such use is not objectionable for environmental reasons, as well as mixtures thereof. Preferred salts are the salts of the polycarboxylic acids such as citric acid, adipic acid, succinic acid, glutaric acid, tartaric acid, sugar acids, and mixtures thereof.

The acids per se can also be used. The acids typically also possess, in addition to their builder effect, the property of an acidifying component, and thus serve also to establish a lower and milder pH for washing or cleaning agents. Worthy of mention in this context are, in particular, citric acid, succinic acid, glutaric acid, adipic acid, gluconic acid, and any mixtures thereof.

Further suitable as builders or deposition inhibitors are polymeric polycarboxylates; these are, for example, the alkali-metal salts of polyacrylic acid or polymethacrylic acid, for example those having a relative molecular weight of 500 to 70,000 g/mol.

The molar weights indicated for polymeric polycarboxylates are, for purposes of this document, weight-averaged molar weights M_{w} of the respective acid form that were determined in principle by means of gel permeation chromatography (GPC), a UV detector having been used. The measurement was performed against an external polyacrylic acid standard that, because of its structural affinity with the polymers being investigated, yielded realistic molecular weight values. These indications deviate considerably from the molecular weight indications in which polystyrenesulfonic acids are used as the standard. The molar weights measured against polystyrenesulfonic acids are usually much higher than the molar weights indicated in this document.

Suitable polymers are, in particular, polyacrylates that preferably have a molecular weight from 2000 to 20,000 g/mol. Because of their superior solubility, of this group the short-chain polyacrylates that have molar weights from 2000 to 10,000 g/ml, and particularly preferably from 3000 to 5000 g/mol, may in turn be preferred.

Copolymeric polycarboxylates, in particular those of acrylic acid with methacrylic acid and of acrylic acid or methacrylic acid with maleic acid, are also suitable. Copolymers of acrylic acid with maleic acid that contain 50 to 90 wt % acrylic acid and 50 to 10 wt % maleic acid have proven particularly suitable. Their relative molecular weight, based on free acids, is generally 2000 to 70,000 g/mol, preferably 20,000 to 50,000 g/mol, and in particular 30,000 to 40,000 g/mol.

The (co)polymeric polycarboxylates can be used as either a powder or an aqueous solution. The (co)polymeric polycarboxylate content of the agents is preferably 0.5 to 20 wt %, in particular 3 to 10 wt %.

Also particularly preferred are biodegradable polymers made up of more than two different monomer units, for example those that contain salts of acrylic acid and maleic acid, as well as vinyl alcohol or vinyl alcohol derivatives, as monomers, or that contain salts of acrylic acid and of 2-alkylallylsulfonic acid, as well as sugar derivatives, as monomers. Further preferred copolymers are those that have, as monomers, preferably acrolein and acrylic acid/acrylic acid salts, or acrolein and vinyl acetate.

Also to be mentioned as further preferred builder substances are polymeric aminodicarboxylic acids, their salts, or their precursor substances. Particularly preferred are polyaspartic acids and their salts and derivatives, which have not only co-builder properties but also a bleach-stabilizing effect.

Other suitable builder substances are polyacetals, which can be obtained by reacting dialdehydes with polyolcarboxylic acids that have 5 to 7 C atoms and at least 3 hydroxyl groups. Preferred polyacetals are obtained from dialdehydes such as glyoxal, glutaraldehyde, terephthalaldehyde, and mixtures thereof, and from polyolcarboxylic acids such as gluconic acid and/or glucoheptonic acid.

Other suitable organic builder substances are dextrins, for example oligomers or polymers of carbohydrates, which can be obtained by partial hydrolysis of starches. The hydrolysis can be performed in accordance with usual, e.g. acid- or enzyme-catalyzed, methods. Preferably these are hydrolysis products having average molar weights in the range from 400 to 500,000 g/mol. A polysaccharide having a dextrose equivalent (DE) in the range from 0.5 to 40, in particular from 2 to 30, is preferred, DE being a common indicator of the reducing effect of a polysaccharide as compared with dextrose, which possesses a DE of 100. Also usable are maltodextrins having a DE between 3 and 20, and dry glucose syrups having a DE between 20 and 37, as well as so-called yellow dextrins and white dextrins having higher molar weights in the range from 2000 to 30,000 g/mol.

The oxidized derivatives of such dextrins are their reaction products with oxidizing agents that are capable of oxidizing at least one alcohol function of the saccharide ring to the carboxylic acid function. A product oxidized at C₆ of the saccharide ring can be particularly advantageous.

Oxydisuccinates and other derivatives of disuccinates, preferably ethylenediaminedisuccinate, are also additional suitable co-builders. Ethylenediamine-N,N′-disuccinate (EDDS) is used here preferably in the form of its sodium or magnesium salts. Also preferred in this context are glycerol disuccinates and glycerol trisuccinates. Suitable utilization quantities in zeolite-containing and/or silicate-containing formulations are 3 to 15 wt %.

Other usable organic co-builders are, for example, acetylated hydroxycarboxylic acids and their salts, which can optionally also be present in lactone form and which contain at least 4 carbon atoms and at least one hydroxy group, as well as a maximum of two acid groups.

Washing or cleaning agents can contain phosphates as detergency builders, preferably alkali-metal phosphates with particular preference for pentasodium or pentapotassium triphosphate (sodium or potassium tripolyphosphate).

“Alkali-metal phosphates” is the summary designation for the alkali-metal (in particular sodium and potassium) salts of the various phosphoric acids, in which context a distinction can be made between metaphosphoric acids (HPO₃)ₙ and orthophosphoric acid H₃PO₄, in addition to higher-molecular-weight representatives. The phosphates offer a combination of advantages: they act as alkali carriers, prevent lime deposits, and furthermore contribute to cleaning performance.

With particular preference, the washing or cleaning agents can contain condensed phosphates as water-softening substances. These substances constitute a group of phosphates, also referred to as fused or thermal phosphates because of how they are manufactured, that can be derived from acid salts of orthophosphoric acid (phosphoric acids) by condensation. The condensed phosphates can be subdivided into the metaphosphates [M^{l}ₙ(PO₃)ₙ] and the polyphosphates (M^{l}ₙ₊₂PₙO₃ₙ₊₁ or M^{l}ₙH₂PₙO₃ₙ₊₁).

The term “metaphosphates” was originally the general designation for condensed phosphates having the composition Mₙ[PₙO₃ₙ] (M=univalent metal), but today is usually limited to salts having ring-shaped cyclo(poly)phosphate anions. The terms tri-, tetra-, penta-, hexametaphosphates, etc. are used for n=3, 4, 5, 6, etc. According to the systematic nomenclature for isopoly anions, for example, the anion for which n=3 is referred to as a cyclotriphosphate.

Metaphosphates are obtained as accompanying constituents of Graham salt (incorrectly referred to as sodium hexametaphosphate) by fusing NaH₂PO₄ at temperatures above 620° C., so-called Maddrell salt also occurring as an intermediary. This and Kurrol's salt are linear polyphosphates that today are usually not included among the metaphosphates, but are likewise usable by preference in the context of the present invention as water-softening substances.

Crystalline, water-insoluble Maddrell salt—(NaPO₃)ₓ where x>1000—which can be obtained at 200-300° C. from NaH₂PO₄, transitions at approx. 600° C. into the cyclic metaphosphate [Na₃(PO₃)₃] that melts at 620° C. The quenched glassy melt is, depending on reaction conditions, either water-soluble Graham salt (NaPO₃)₄₀₋₅₀ or a glassy condensed phosphate of the composition (NaPO₃)₁₅₋₂₀ that is known as Calgon. The misleading designation “hexametaphosphates” is still in use for both products. So-called Kurrol's salt—(NaPO₃)ₙ where n>>5000—is also produced from a 600° C. melt of Maddrell salt if it is left to stand briefly at approx. 500° C. It forms water-soluble, high-molecular-weight polymer fibers.

The “hexametaphosphates” Budit® H6 and H8 of the Budenheim Co. have proven to be particularly preferred water-softening substances from the aforementioned classes of the condensed phosphates.

A substance class having co-builder properties is represented by the phosphonates. These are, in particular, hydroxyalkane- and aminoalkanephosphonates. Among the hydroxyalkanephosphonates, 1-hydroxyethane-1,1-diphosphonate (HEDP) is particularly important as a co-builder. It is preferably used as a sodium salt, in which context the disodium salt reacts neutrally and the tetrasodium salt in alkaline fashion (pH 9). Suitable aminoalkanephosphonates are preferably ethylenediamine tetramethylenephosphonate (EDTMP), diethylenetriamine pentamethylenephosphonate (DTPMP), and their higher homologs. They are preferably used in the form of the neutrally reacting sodium salts, e.g. as the hexasodium salt of EDTMP or as the hepta- and octasodium salt of DTPMP. Of the class of phosphonates, HEDP is preferably used as a builder. The aminoalkanephosphonates furthermore possess a pronounced heavy-metal binding capability. It may accordingly be preferred, especially when the agents also contain bleaches, to use aminoalkanephosphonates, in particular DTPMP, or mixtures of the aforesaid phosphonates.

Suitable silicate builders are the crystalline, layered sodium silicates of the general formula NaMSiₓO₂ₓ₊₁.yH₂O, where M denotes sodium or hydrogen, x a number from 1.9 to 4, and y is a number from 0 to 20, and preferred values for x are 2, 3, or 4. Preferred crystalline layered silicates having the formula indicated above are those in which M denotes sodium and x assumes the value 2 or 3. Both β- and δ-sodium disilicates Na₂Si₂O₅.yH₂O are particularly preferred.

Also usable are amorphous sodium silicates having a Na₂O:SiO₂ modulus of 1:2 to 1:3.3, preferably 1:2 to 1:2.8, and in particular 1:2 to 1:2.6, which are dissolution-delayed and exhibit secondary washing properties. A dissolution delay as compared with conventional amorphous sodium silicates can have been brought about in various ways, for example by surface treatment, compounding, compacting, or overdrying. In the context of this invention, the term “amorphous” is also understood to mean “X-amorphous.” In other words, in X-ray diffraction experiments the silicates yield not the sharp X-ray reflections that are typical of crystalline substances, but instead at most one or more maxima in the scattered X radiation, having a width of several degree units of the diffraction angle. Particularly good builder properties can, however, very easily be obtained even if the silicate particles yield blurred or even sharp diffraction maxima in electron beam diffraction experiments. This may be interpreted to mean that the products have microcrystalline regions 10 to several hundred nm in size, values of up to a maximum of 50 nm, and in particular a maximum of 20 nm, being preferred. So-called X-amorphous silicates of this kind also exhibit a dissolution delay as compared with conventional water glasses. Compacted amorphous silicates, compounded amorphous silicates, and overdried X-amorphous silicates are particularly preferred.

The finely crystalline synthetic zeolite containing bound water that is useable is preferably zeolite A and/or zeolite P. Zeolite MAP® (commercial product of the Crosfield Co.) is particularly preferred as zeolite P. Also suitable, however, are zeolite X as well as mixtures of A, X, and/or P. Also commercially available and preferred for use in the context of the present invention is, for example, a co-crystal of zeolite X and zeolite A (approx. 80 wt % zeolite X) that is marketed by CONDEA Augusta S.p.A. under the trade name VEGOBOND AX® and can be described by the formula

nNa₂O.(1−n)K₂O.Al₂O₃.(2-2.5)SiO₂.(3.5-5.5)H₂O.

Suitable zeolites exhibit an average particle size of less than 10 μm (volume distribution; measured with a Coulter Counter), and preferably contain 18 to 22 wt %, in particular 20 to 22 wt %, bound water.

In addition to the detergency builders, acidifying agents, chelate complex-forming agents, or deposition-inhibiting polymers are, in particular, further preferred ingredients of washing or cleaning agents.

### Acidifying Agents

Useful acidifying agents are both inorganic acids and organic acids, provided they are compatible with the other ingredients. For reasons of consumer protection and handling safety, the solid mono-, oligo-, and polycarboxylic acids are usable in particular. Preferred from this group in turn are citric acid, tartaric acid, succinic acid, malonic acid, adipic acid, maleic acid, fumaric acid, oxalic acid, and polyacrylic acid. The anhydrides of these acids can also be used as acidifying agents, maleic acid anhydride and succinic acid anhydride in particular being commercially available. Organic sulfonic acids such as amidosulfonic acid are likewise usable. Sokalan® DCS (trademark of BASF), a mixture of succinic acid (max. 31 wt %), glutaric acid (max. 50 wt %) and adipic acid (max. 33 wt %), is commercially obtainable and likewise preferably usable as an acidifying agent in the context of the present invention.

### Chelate Complex-Forming Agents

A further possible group of ingredients is represented by the chelate complex-forming agents. Chelate complex-forming agents are substances that form cyclic compounds with metal ions, a single ligand occupying more than one coordination site on a central atom, i.e. being at least “double-toothed.” In this case, therefore, normally elongated compounds are closed up into rings by formation of a complex via an ion. The number of bound ligands depends on the coordination number of the central ion.

Common chelate complex-forming agents that are preferred in the context of the present invention are, for example, polyoxycarboxylic acids, polyamines, ethylenediaminetetraacetic acid (EDTA), and nitrilotriacetic acid (NTA). Also usable are complex-forming polymers, i.e. polymers that carry, either in the main chain itself or laterally thereto, functional groups that can act as ligands and that react with suitable metal atoms, generally forming chelate complexes. The polymer-bound ligands of the resulting metal complexes can derive from only one macromolecule or can belong to different polymer chains. The latter case results in crosslinking of the material, provided the complex-forming polymers were not already crosslinked via covalent bonds.

Complexing groups (ligands) of usual complex-forming polymers are iminodiacetic acid, hydroxyquinoline, thiourea, guanidine, dithiocarbamate, hydroxamic acid, amide oxime, aminophosphoric acid, (cyclic) polyamino, mercapto, 1,3-dicarbonyl, and crown ether radicals, having in some cases very specific activities with respect to ions of various metals. Fundamental polymers of many complex-forming polymers that are also commercially important are polystyrene, polyacrylates, polyacrylonitriles, polyvinyl alcohols, polyvinyl pyridines, and polyethylene imines. Natural polymers such as cellulose, starch, or chitin are also complex-forming polymers. The latter can additionally be equipped with further ligand functionalities by polymer-analogous conversions.

Particularly preferred in the context of the present invention are washing or cleaning agents that contain one or more chelate complex formers from the groups of the

(i) polycarboxylic acids in which the sum of the carboxyl and (if applicable) hydroxyl groups is at least 5;
(ii) nitrogen-containing mono- or polycarboxylic acids;
(iii) geminal diphosphonic acids;
(iv) aminophosphonic acids
(v) phosphonopolycarboxylic acids
(vi) cyclodextrins,
in quantities above 0.1 wt %, preferably above 0.5 wt %, particularly preferably above 1 wt %, and in particular above 2.5 wt %, based in each case on the weight of the agent.

All complex formers of the existing art can be used in the context of the present invention. They can belong to different chemical groups. The following are preferably used, individually or mixed with one another:
a) polycarboxylic acids in which the sum of the carboxyl and (if applicable) hydroxyl groups is at least 5, such as gluconic acid;
b) nitrogen-containing mono- or polycarboxylic acids such as ethylenediamine tetraacetic acid (EDTA), N-hydroxyethyl ethylenediaminetetraacetic acid, diethylenediaminepentaacetic acid, hydroxyethyliminodiacetic acid, nitridodiacetic acid 3-propionic acid, isoserine diacetic acid, N,N-di-(β-hydroxyethyl)glycine, N-(1,2-dicarboxy-2-hydroxyethyl)glycine, N-(1,2-dicarboxy-2-hydroxyethyl)aspartic acid, or nitrilotriacetic acid (NTA);
c) geminal diphosphonic acids such as 1-hydroxyethane-1,1-diphosphonic acid (HEDP), its higher homologs having up to 8 carbon atoms, and hydroxy- or amino-group-containing derivatives thereof, and 1-aminoethane-1,1-diphosphonic acid, its higher homologs having up to 8 carbon atoms, and hydroxy- or amino-group-containing derivatives thereof;
d) aminophosphonic acids, such as ethylenediaminetetra(methylphosphonic acid), diethylenetriaminepenta(methylenephosphonic acid), or nitrilotri(methylenephosphonic acid);
e) phosphonopolycarboxylic acids such as 2-phosphonobutane-1,2,4-tricarboxylic acid; and
f) cyclodextrins.

In the context of this patent application, polycarboxylic acids (a) are understood as carboxylic acids (including monocarboxylic acids) in which the sum of the carboxyl and hydroxyl groups contained in the molecule is at least 5. Complex formers from the group of the nitrogen-containing polycarboxylic acids, in particular EDTA, are preferred. At the required alkaline pH values of the treatment solutions, these complex formers are present at least in part as anions. It is immaterial whether they are introduced in the form of the acids or in the form of salts. If they are used as salts, alkali, ammonium, or alkylammonium salts, in particular sodium salts, are preferred.

### Deposition-Inhibiting Polymers

Deposition-inhibiting polymers can likewise be contained in washing and cleaning agents. These substances, which can have a variety of chemical structures, derive e.g. from the groups of the low-molecular-weight polyacrylates having molar weights between 1000 and 20,000 dalton, polymers having molar weights below 15,000 dalton being preferred.

Deposition-inhibiting polymers can also exhibit co-builder properties. Polycarboxylates/polycarboxylic acids, polymeric polycarboxylates, aspartic acid, polyacetals, dextrins, further organic co-builders, and phosphonates can be used in particular in the agents that contain the end products of the method according to the present invention. These substance classes have been described above.

### Bleaching Agents

Of the compounds yielding H₂O₂ in water that serve as bleaching agents, sodium perborate tetrahydrate and sodium perborate monohydrate are of particular importance. Other usable bleaching agents are, for example, sodium percarbonate, peroxypyrophosphates, citrate perhydrates, and peracid salts or peracids that yield H₂O₂, such as perbenzoates, peroxyphthalates, diperazelaic acid, phthaloimino peracid, or diperdodecanedioic acid. Preferred washing or cleaning agents can also contain bleaching agents from the group of the organic bleaching agents. Typical organic bleaching agents are the diacyl peroxides, for example dibenzoyl peroxide. Further typical organic bleaching agents are the peroxy acids, the alkylperoxy acids and arylperoxy acids being mentioned in particular as examples. Preferred representatives are (a) peroxybenzoic acid and its ring-substituted derivatives, such as alkylperoxybenzoic acids but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid [phthaloiminoperoxyhexanoic acid (PAP)], o-carboxybenzamidoperoxycaproic acid, N-nonenylamidoperadipic acid, and N-nonenylamidopersuccinates, and (c) peroxydicarboxylic acids such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyl-di(6-aminopercaproic) acid.

Substances that release chlorine or bromine can also be used as bleaching agents. Appropriate among the materials releasing chlorine or bromine are, for example, heterocyclic N-bromamides and N-chloramides, for example trichloroisocyanuric acid, tribromoisocyanuric acid, dibromoisocyanuric acid, and/or dichloroisocyanuric acid (DICA) and/or their salts with cations such as potassium and sodium. Hydantoin compounds such as 1,3-dichloro-5,5-dimethylhydantoin are also suitable.

### Bleach Activators

Bleach activators assist the action of bleaching agents. Known bleach activators are compounds that contain one or more N- or O-acyl groups, such as substances from the classes of the anhydrides, the esters, the imides, and the acylated imidazoles or oximes. Examples are tetraacetylethylendiamine (TAED), tetraacetylmethylendiamine (TAMD), and tetraacetylhexylendiamine (TAHD), but also pentaacetylglucose (PAG), 1,5-diacetyl-2,2-dioxohexahydro-1,3,5-triazine (DADHT), and isatoic acid anhydride (ISA).

Compounds that, under perhydrolysis conditions, yield aliphatic peroxycarboxylic acids having preferably 1 to 10 C atoms, in particular 2 to 4 C atoms, and/or optionally substituted perbenzoic acid, can be used as bleach activators. Substances that carry O- and/or N-acyl groups having the aforesaid number of C atoms, and/or optionally substituted benzoyl groups, are suitable. Multiply acylated alkylenediamines, in particular tetraacetylethylendiamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoylsuccinimide (NOSI), acylated phenolsulfonates, in particular n-nonanoyl or isononanoyl oxybenzenesulfonate (n- or iso-NOBS), carboxylic acid anhydrides, in particular phthalic acid anhydrides, acylated polyvalent alcohols, in particular triacetin, ethylene glycol diacetate, 2,5-diacetoxy-2,5-dihydrofuran, n-methylmorpholinium acetonitrile methyl sulfate (MMA), as well as acetylated sorbitol and mannitol and mixtures thereof (SORMAN), acylated sugar derivatives, in particular pentaacetylglucose (PAG), pentaacetylfructose, tetraacetylxylose and octaacetyllactose, as well as acetylated, optionally N-alkylated glucamine und gluconolactone, and/or N-acylated lactams, for example N-benzoylcaprolactam, are preferred. Hydrophilically substituted acyl acetates and acyl lactams are also used in preferred fashion. Combinations of conventional bleach activators can also be used.

It is preferred to use bleach activators from the group of the multiply acylated alkylenediamines, in particular tetraacetylethylendiamine (TAED), N-acylimides, in particular N-nonanoylsuccinimide (NOSI), acylated phenolsulfonates, in particular n-nonanoyl or isononanoyl oxybenzenesulfonate (n- or iso-NOBS), n-methylmorpholinium acetonitrile methyl sulfate (MMA), preferably in quantities up to 10 wt %, in particular 0.1 wt % to 8 wt %, especially 2 to 8 wt %, and particularly preferably 2 to 6 wt %, based on the entire agent.

### Bleach Catalysts

In addition to or instead of the conventional bleach activators, so-called bleach catalysts can also be contained in the products deriving from the method according to the present invention. These substances are bleach-intensifying transition-metal salts or transition-metal complexes such as, for example, Mn, Fe, Co, Ru, or Mo salt complexes or carbonyl complexes. Mn, Fe, Co, Ru, Mo, Ti, V, and Cu complexes having nitrogen-containing tripod ligands, as well as Co, Fe, Cu, and Ru ammine complexes, are also usable as bleach catalysts.

Bleach-intensifying transition-metal complexes, in particular having the central atoms Mn, Fe, Co, Cu, Mo, V, Ti, and/or Ru, preferably selected from the group of the manganese and/or cobalt salts and/or complexes, particularly preferably the cobalt(ammine) complexes, the cobalt(acetate) complexes, the cobalt(carbonyl) complexes, the chlorides of cobalt or manganese, and manganese sulfate, are used in usual quantities, preferably in a quantity up to 5 wt %, in particular from 0.0025 wt % to 1 wt %, and particularly preferably from 0.01 wt % to 0.25 wt %, based in each case on the entire agent. Even more bleach activator can, however, be used in specific cases.

### Enzymes

Washing or cleaning agents can contain enzymes in order to enhance washing or cleaning performance, all enzymes established in the existing art for those purposes being usable in principle. These include, in particular, proteases, amylases, lipases, hemicellulases, cellulases, or oxidoreductases, as well as preferably mixtures thereof. These enzymes are, in principle, of natural origin; improved variants based on the natural molecules are available for use in washing and cleaning agents and are correspondingly preferred for use. Preferred agents contain enzymes preferably in total quantities from 1×10⁻⁶ to 5 wt %, based on active protein. The protein concentration can be determined with known methods, for example the bicinchoninic acid method (BCA: 2,2′-diquinolyl-4,4′-dicarboxylic acid), or the biuret method.

Among the proteases, those of the subtilisin type are preferred. Examples thereof are the subtilisins BPN′ and Carlsberg, protease PB92, subtilisins 147 and 309, the alkaline protease from Bacillus lentus, subtilisin DY, and the enzymes (to be classified, however, as subtilases rather than as subtilisins in the strict sense) thermitase, proteinase K, and proteases TW3 and TW7. Subtilisin Carlsberg is obtainable in further developed form under the trade name Alcalase® from Novozymes A/S, Bagsvaerd, Denmark. Subtilisins 147 and 309 are marketed by Novozymes under the trade names Esperase® and Savinase®, respectively. The variants listed under the designation BLAP® are derived from the protease from Bacillus lentus DSM 5483.

Other usable proteases are, for example, the enzymes obtainable under the trade names Durazym®, Relase®, Everlase®, Nafizym, Natalase®, Kannase®, and Ovozymese® from Novozymes, under the trade names Purafect®, Purafect® OxP and Properase® from Genencor, under the trade name Protosol® from Advanced Biochemicals Ltd., Thane, India, under the trade name Wuxi® from Wuxi Snyder Bioproducts Ltd., China, under the trade names Proleather® and Protease P® from Amano Pharmaceuticals Ltd., Nagoya, Japan, and under the designation Proteinase K-16 from Kao Corp., Tokyo, Japan.

Examples of amylases usable according to the present invention are the α-amylases from Bacillus licheniformis, from B. amyloliquefaciens, or from B. stearothermophilus, and their further developments improved for use in washing and cleaning agents. The enzyme from B. licheniformus is available from Novozymes under the name Termamyl®, and from Genencor under the name Purastar® ST. Further-developed products of these α-amylases are available from Novozymes under the trade names Duramyl® and Termamyl® ultra, from Genencor under the name Purastar® OxAm, and from Daiwa Seiko Inc., Tokyo, Japan, as Keistase®. The α-amylase from B. amyloliquefaciens is marketed by Novozymes under the name BAN®, and derived variants of the α-amylase from B. stearothermophilus are marketed, again by Novozymes, under the names BSG® and Novamyl®.

Additionally to be highlighted for this purpose are the α-amylase from Bacillus sp. A 7-7 (DSM 12368) and the cyclodextrin-glucanotransferase (CGTase) from B. agaradherens (DSM 9948); fusion products of the aforesaid molecules are likewise usable.

The further developments of the α-amylase from Aspergillus niger and A. oryzae, obtainable from Novozymes under the trade names Fungamyl®, are also suitable. A further commercial product is, for example, Amylase-LT®.

Washing or cleaning agents can contain lipases or cutinases, in particular because of their triglyceride-cleaving activities but also in order to generate peracids in situ from suitable precursors. These include, for example, the lipases obtainable originally from Humicola lanuginosa (Thermomyces lanuginosus) or further-developed lipases, in particular those having the D96L amino acid exchange. They are marketed, for example, by Novozymes under the trade names Lipolase®, Lipolase® Ultra, LipoPrime®, Lipozyme®, and Lipex®. The cutinases that were originally isolated from Fusarium solani pisi and Humicola insolens are moreover usable. Additional usable lipases are obtainable from the Amano company under the designations Lipase CE®, Lipase P®, Lipase B®, or Lipase CES®, Lipase AKG®, Bacillis sp. Lipase®, Lipase AP®, Lipase M-AP®, and Lipase AML®. The lipases and cutinases from, for example, Genencor, whose starting enzymes were originally isolated from Pseudomonas mendocina and Fusarium solanii, are usable. To be mentioned as further important commercial products are the preparations M1 Lipase® and Lipomax® originally marketed by Gist-Brocades, and the enzymes marketed by Meito Sangyo KK, Japan, under the names Lipase MY-30®, Lipase OF®, and Lipase PL®, as well as the Lumafast® product of Genencor.

Washing or cleaning agents can, especially if they are intended for the treatment of textiles, contain cellulases, depending on the purpose as pure enzymes, as enzyme preparations, or in the form of mixtures in which the individual components advantageously complement one another in terms of their various performance aspects. These performance aspects include, in particular, contributions to primary washing performance, the secondary washing performance of the agent (anti-redeposition effect or graying inhibition), and brightening (fabric effect), or even exertion of a “stone-washed” effect.

A usable fungus-based cellulase preparation rich in endoglucanase (EG), and its further developments, are offered by Novozymes under the trade name Celluzyme®. The products Endolase® and Carezyme®, likewise obtainable from Novozymes, are based on the 50 kD EG and 43 kD EG, respectively, from H. insolens DSM 1800. Further possible commercial products of this company are Cellusoft® and Renozyme®. The 20 kD EG cellulase from Melanocarpus that is available from AB Enzymes, Finland, under the trade names Ecostone® and Biotouch® is also usable. Other commercial products of AB Enzymes are Econase® and Ecopulp®. A further suitable cellulase from Bacillus sp. CBS 670.93 is obtainable from Genencor under the trade name Puradax®. Other commercial products of Genencor are “Genencor detergent cellulase L” and IndiAge® Neutra.

Washing or cleaning agents can contain further enzymes that are grouped under the term “hemicellulases.” These include, for example, mannanases, xanthanlyases, pectinlyases (=pectinases), pectinesterases, pectatelyases, xyloglucanases (=xylanases), pullulanases, and β-glucanases. Suitable mannanases are obtainable, for example, under the names Gamanase® and Pektinex AR® from Novozymes, under the name Rohapec® B1L from AB Enzymes, and under the name Pyrolase® from Diversa Corp., San Diego, Calif., USA. The β-glucanase obtained from B. subtilis is available under the name Cereflo® from Novozymes.

To enhance the bleaching effect, washing and cleaning agents can contain oxidoreductases, for example oxidases, oxygenases, catalases, peroxidases such as halo-, chloro-, bromo-, lignin, glucose, or manganese peroxidases, dioxygenases, or laccases (phenoloxidases, polyphenoloxidases). Suitable commercial products that may be mentioned are Denilite® 1 and 2 of Novozymes. Advantageously, preferably organic, particularly preferably aromatic compounds that interact with the enzymes are additionally added in order to enhance the activity of the relevant oxidoreductases (enhancers) or, if there is a large difference in redox potentials between the oxidizing enzymes and the dirt particles, to ensure electron flow (mediators).

The enzymes used in washing and cleaning agents derive either originally from microorganisms, for example the genera Bacillus, Streptomyces, Humicola, or Pseudomonas, and/or are produced by suitable microorganisms in accordance with biotechnological methods known per se, for example by transgenic expression hosts of Bacillus species or filamentous fungi.

Purification of the relevant enzymes is favorably accomplished by way of methods established per se, for example by precipitation, sedimentation, concentration, filtration of the liquid phases, microfiltration, ultrafiltration, the action of chemicals, deodorization, or suitable combinations of these steps.

Washing or cleaning agents can have the enzymes added to them in any form established according to the existing art. These include, for example, the solid preparations obtained by granulation, extrusion, or lyophilization or, especially in the case of liquid or gelled agents, solutions of the enzymes, advantageously as concentrated as possible, low in water, and/or with stabilizers added.

Alternatively, the enzymes can be encapsulated for both the solid and the liquid administration form, for example by spray-drying or extrusion of the enzyme solution together with a preferably natural polymer, or in the form of capsules, for example ones in which the enzymes are enclosed e.g. in a solidified gel, or in those of the core-shell type, in which an enzyme-containing core is covered with a protective layer impermeable to water, air, and/or chemicals. Further active substances, for example stabilizers, emulsifiers, pigments, bleaching agents, or dyes, can additionally be applied in superimposed layers. Such capsules are applied in accordance with methods known per se, for example by vibratory or rolling granulation or in fluidized-bed processes. Such granules are advantageously low in dust, e.g. as a result of the application of polymer film-forming agents, and are stable in storage thanks to the coating.

It is additionally possible to package two or more enzymes together, so that a single granule exhibits several enzyme activities.

A protein and/or enzyme contained in a washing or cleaning agent can be protected, especially during storage, from damage such as, for example, inactivation, denaturing, or decomposition, e.g. resulting from physical influences, oxidation, or proteolytic cleavage. An inhibition of proteolysis is particularly preferred in the context of microbial recovery of the proteins and/or enzymes, in particular when the agents also contain proteases. Stabilizers can preferably be used for this purpose.

Reversible protease inhibitors are one group of stabilizers. Benzamidine hydrochloride, borax, boric acids, boronic acids, or their salts or esters are often used, among them principally derivatives having aromatic groups, e.g. ortho-substituted, meta-substituted, or para-substituted phenylboronic acids, or their salts or esters. Peptide aldehydes, i.e. oligopeptides having a reduced C terminus, are also suitable. Ovomucoid and leupeptin, among others, may be mentioned as peptide protease inhibitors; an additional option is the creation of fusion proteins from proteases and peptide inhibitors.

Further enzyme stabilizers are aminoalcohols such as mono-, di-, triethanol- and -propanolamine and mixtures thereof, aliphatic carboxylic acids up to C₁₂ such as succinic acid, other dicarboxylic acids, or salts of the aforesaid acids. End-group-terminated fatty acid amide alkoxylates are also usable as stabilizers.

Lower aliphatic alcohols, but principally polyols, for example glycerol, ethylene glycol, propylene glycol, or sorbitol, are other frequently used enzyme stabilizers. Diglycerol phosphate also protects against denaturing due to physical influences. Calcium salts are likewise used, for example calcium acetate or calcium formate, as well as magnesium salts.

Polyamide oligomers or polymeric compounds such as lignin, water-soluble vinyl copolymers, or cellulose ethers, acrylic polymers, and/or polyamides stabilize the enzyme preparation with respect to physical influences or pH fluctuations, inter alia. Polyamine-N-oxide-containing polymers act simultaneously as enzyme stabilizers and as color transfer inhibitors. Other polymeric stabilizers are the linear C₈-C₁₈ polyoxyalkylenes. Alkyl polyglycosides can likewise stabilize the enzymatic components of the preferred agent according to the present invention, and even improve its performance. Crosslinked nitrogen-containing compounds perform a dual function as soil-release agents and as enzyme stabilizers.

Reducing agents and antioxidants, such as sodium sulfite or reducing sugars, increase the stability of the enzymes with respect to oxidative breakdown.

Combinations of stabilizers are preferably used, for example made up of polyols, boric acid and/or borax, the combination of boric acid or borate, reducing salts, and succinic acid or other dicarboxylic acids, or the combination of boric acid or borate with polyols or polyamino compounds and with reducing salts. The effect of peptide aldehyde stabilizers is enhanced by the combination with boric acid and/or boric acid derivatives and polyols, and further enhanced by the additional use of divalent cations, for example calcium ions.

The use of liquid enzyme formulations is particularly preferred in the context of the present invention. It is preferred here to use the additional enzymes and/or enzyme preparations, preferably solid and/or liquid protease preparations and/or amylase preparations, in quantities from 1 to 5 wt %, preferably 1.5 to 4.5, and in particular 2 to 4 wt %, based in each case on the entire agent.

### Dyes and Fragrances

Dyes and fragrances can be added to the washing or cleaning agents in order to improve the aesthetic impression of the resulting products and make available to the consumer not only performance but also a visually and sensorially “typical and unmistakable” product. Individual aroma compounds, e.g. the synthetic products of the ester, ether, aldehyde, ketone, alcohol, and hydrocarbon types, can be used as perfume oils or fragrances. Aroma compounds of the ester type are, for example, benzyl acetate, phenoxyethyl isobutyrate, p-tert.-butylcyclohexyl acetate, linalyl acetate, dimethylbenzylcarbinyl acetate, phenylethyl acetate, linalyl benzoate, benzyl formate, ethylmethylphenyl glycinate, allylcyclohexyl propionate, styrallyl propionate, and benzyl salicylate. The ethers include, for example, benzylethyl ether; the aldehydes, for example, the linear alkanals having 8-18 C atoms, citral, citronellal, citronellyloxyacetaldehyde, cyclamenaldehyde, hydroxycitronellal, lilial and bourgeonal; the ketones, for example, the ionones, α-isomethylionone und methylcedryl ketone; the alcohols, anethol, citronellol, eugenol, geraniol, linalool, phenylethyl alcohol and terpineol; and the hydrocarbons include principally the terpenes such as limonene and pinene. Preferably, however, mixtures of different aromas that together produce an attractive fragrance note are used. Such perfume oils can also contain natural aroma mixtures, such as those accessible from plant sources, for example pine, citrus, jasmine, patchouli, rose, or ylang-ylang oil. Also suitable are muscatel, salvia oil, chamomile oil, clove oil, lemon balm oil, mint oil, cinnamon leaf oil, linden blossom oil, juniper berry oil, vetiver oil, olibanum oil, galbanum oil, and labdanum oil, as well as orange blossom oil, neroli oil, orange peel oil, and sandalwood oil.

The fragrances can be incorporated directly into the agents, but it may also be advantageous to apply the fragrances onto carriers that intensify adhesion of the perfume on the laundry and ensure a slower fragrance release for longer-lasting fragrance. Cyclodextrins, for example, have proven successful as carrier materials of this kind; the cyclodextrin-perfume complexes can additionally be coated with further adjuvants.

In order to improve the aesthetic impression of the washing or cleaning agent, it (or parts thereof) can be colored with suitable dyes. Preferred dyes, the selection of which will present no difficulty whatsoever to one skilled in the art, possess excellent shelf stability and insensitivity to the other ingredients of the agents and to light, and no pronounced substantivity with respect to the substrates to be treated with the dye-containing agents, such as glass, ceramics, or plastic dishes, in order not to color them.

### Optical Brighteners

Washing or cleaning agents can contain, as optical brighteners, derivatives of diaminostilbenesulfonic acid or its alkali-metal salts. Suitable, for example, are salts of 4,4′-bis(2-anilino-4-morpholino-1,3,5-triazinyl-6-amino)stilbene-2,2′-disulfonic acid, or compounds of similar structure that carry, instead of the morpholino group, a diethanolamino group, a methylamino group, an anilino group, or a 2-methoxyethylamino group. Brighteners of the substituted diphenylstyryl type can also be present, e.g. the alkali salts of 4,4′-bis(2-sulfostyryl)diphenyl, of 4,4′-bis(4-chloro-3-sulfostyryl)diphenyl, or of 4-(4-chlorostyryl)-4′-(2-sulfostyryl)diphenyl. Mixtures of the aforesaid brighteners can also be used.

### Manufacture of Shaped Elements

The end products of the method according to the present invention not only can be mixed into particulate washing or cleaning agents, but also can be used in washing- or cleaning-agent tablets. Surprisingly, the solubility of such tablets is improved by the use of the end products of the method according to the present invention, as compared with tablets of the same hardness and identical composition that contain no end products of the method according to the present invention. A further subject of the present invention is therefore the use of the end products of the method according to the present invention for the manufacture of washing agents, in particular of washing-agent tablets.

The manufacture of such tablets using the end products of the method according to the present invention is described below.

The manufacture of shaped elements having washing and cleaning activity is accomplished by applying pressure to a mixture that is to be compressed and is located in the cavity of a press. In the simplest instance of shaped-element manufacture, hereinafter simply called “tableting,” the mixture to be tableted is compressed directly, i.e. without prior granulation. The advantages of this so-called direct tableting are its simple and economical application, since no further method steps and consequently also no further equipment is required. Contrasting with these advantages, however, are also disadvantages. For example, a powder mixture that is to be directly tableted must possess sufficient plastic deformability and have good flow properties; furthermore, it must exhibit no demixing tendencies during storage, transport, and filling of the mold. For many substance mixtures, these three prerequisites can be met only with extraordinary difficulty, so that direct tableting is not often utilized especially in the manufacture of washing- and cleaning-agent tablets. The usual procedure for manufacturing washing- and cleaning-agent tablets therefore begins with powdered components (“primary particles”) that, by way of suitable methods, are agglomerated or granulated into secondary particles having a larger particle diameter. These granules, or mixtures of different granules, are then mixed with individual powdered additives and subjected to tableting. In the context of the present invention, this means that the end products of the method according to the present invention are processed, with further ingredients that can likewise be present in granular form, into a premix.

Prior to compression of the particulate premix into washing- and cleaning-agent shaped elements, the premix can be “dusted” with finely particulate surface treatment agents. This can be advantageous in terms of the finish and physical properties both of the premix (storage, compression) and of the finished washing- and cleaning-agent shaped elements. Finely particulate dusting agents are well known in the existing art, zeolites, silicates, or other inorganic salts usually being used. Preferably, however, the premix is “dusted” with finely particulate zeolite, zeolites of the faujasite type being preferred. In the context of the present invention, the term “zeolite of the faujasite type” characterizes all three zeolites that constitute the faujasite subgroup of zeolite structural group 4 (cf. Donald W. Breck: “Zeolite Molecular Sieves,” John Wiley & Sons, New York, London, Sydney, Toronto, 1974, page 92). In addition to zeolite X, zeolite Y and faujasite as well as mixtures of those compounds are usable, pure zeolite X being preferred.

Mixtures or co-crystals of zeolites of the faujasite type with other zeolites, which need not obligatorily belong to zeolite structural group 4, are also usable as dusting agents; it is advantageous if at least 50 wt % of the dusting agent is constituted by a zeolite of the faujasite type.

Preferred in the context of the present invention are washing- and cleaning-agent shaped elements that are made of a particulate premix that contains granular components and subsequently mixed-in powdered substances, the or one of the powdered components subsequently mixed in being a zeolite of the faujasite type having particle sizes below 100 μm, preferably below 10 μm, and in particular below 5 μm, and constituting at least 0.2 wt %, preferably at least 0.5 wt %, and in particular more than 1 wt % of the premix to be compressed.

In addition to the end products of the method according to the present invention, the premixes to be compressed can additionally contain one or more substances from the group of the bleaching agents, bleach activators, enzymes, pH adjusting agents, fragrances, perfume carriers, fluorescing agents, dyes, foam inhibitors, silicone oils, anti-redeposition agents, optical brighteners, graying inhibitors, color transfer inhibitors, and corrosion inhibitors. These substances have been described above.

Manufacture of the shaped elements is accomplished firstly by dry mixing of the constituents, which can be entirely or partly pre-granulated, and by subsequent shaping, in particular compression into tablets, in which context known methods can be resorted to. For manufacture of the preferred shaped elements, the premix is compacted in a so-called mold between two dies, yielding a solid compressed body. This operation, which will be referred to hereinafter for brevity's sake as tableting, is subdivided into four portions: metering, compaction (elastic deformation), plastic deformation, and ejection.

Firstly the premix is introduced into the mold, the fill quantity and therefore the weight and the shape of the resulting shaped element being determined by the position of the lower die and the shape of the pressing tool. Consistent metering even at high shaped-element throughput rates is preferably achieved by volumetric metering of the premix. As tableting proceeds, the upper die comes into contact with the premix and moves farther downward toward the lower die. This compaction causes the particles of the premix to be pressed closer to one another, while the cavity volume inside the filled material between the dies continuously decreases. Beyond a certain position of the upper die (and therefore above a certain pressure on the premix), plastic deformation begins, in which the particles merge together and formation of the shaped element occurs. Depending on the physical properties of the premix, some of the premix particles are also crushed, and at even higher pressures a sintering of the premix occurs. As the pressing speed rises, i.e. at high throughput rates, the elastic deformation phase becomes increasingly shorter, so that the resulting shaped elements may exhibit cavities of varying sizes. In the last phase of tableting, the completed shaped elements are pushed out of the mold by the lower die, and are carried away by downstream transport devices. At this point in time only the weight of the shaped element is completely defined, since physical processes (rebound, crystallographic effects, cooling, etc.) can still cause the shape and size of the compacts to change.

Tableting is performed in commercially available tableting presses that can be equipped in principle with single or double dies. In the latter case only the upper die is used to build up pressure; the lower die also moves toward the upper die during the pressing process, while the upper die pushes downward. For small production volumes it is preferred to use eccentric tableting presses in which the die or dies are attached to an eccentric disk that in turn is mounted on a shaft having a specific rotation speed. The motion of these pressing dies is comparable to the manner of operation of a conventional four-stroke engine. Compression can be accomplished using one upper and one lower die, but multiple dies can also be attached to one eccentric disk, the number of mold orifices being correspondingly increased. The throughput rates of eccentric presses vary, depending on type, from a few hundred to a maximum of 3,000 tablets per hour.

Rotary tablet presses, in which a larger number of molds is arranged in a circle on a so-called mold table, are selected for higher throughput rates. The number of molds varies, depending on the model, from six to 55, even larger molds being commercially available. Each mold on the mold table has an upper and a lower die associated with it; once again the applied pressure can be actively built up only by the upper or lower die, but also by both dies. The mold table and the dies move about a common vertically oriented axis, the dies being brought during rotation, with the aid of rail-like curved tracks, into the positions for filling, compaction, plastic deformation, and ejection. At the points where a particularly pronounced raising or lowering of the dies is necessary (filling, compaction, ejection), these curved tracks are assisted by additional press-down elements, pull-down rails, and lifting tracks. The molds are filled via a rigidly arranged delivery device called the filling shoe, which is connected to a reservoir for the premix. The applied pressure on the premix is individually adjustable by way of the pressing travels for the upper and lower dies, pressure being built up as the die shaft heads roll past displaceable pressure rollers.

To increase the throughput rate, rotary presses can also be equipped with two filling shoes, in which case only a half-circle rotation is necessary in order to produce a tablet. For the production of two-layer and multi-layer shaped elements, multiple filling shoes are arranged one behind the other, and the slightly compressed first layer is not ejected before further filling. With appropriate process control, it is possible in this fashion also to produce coated tablets and core tablets that have an onion-like structure; in the case of core tablets, the top of the core or of the core layers is not covered and thus remains visible. Rotary tableting presses can also be fitted with single or multiple molds so that, for example, an outer circle having 50 orifices and an inner circle having 35 orifices can be used simultaneously for compression. The throughput rates of modern rotary tableting presses are over a million shaped elements per hour.

In the context of tableting with rotary presses, it has proven advantageous to perform tableting with the smallest possible fluctuations in tablet weight. This also allows fluctuations in tablet hardness to be reduced. Small weight fluctuations can be achieved in the following fashion:

use of plastic inserts having small thickness tolerances

low rotor rotation speed

large filling shoes

coordination between filling shoe blade speed and rotor rotation speed

constant powder height in the filling shoe

decoupling of filling shoe and powder supply.

All anti-adhesion coatings known in the art are suitable for reducing die caking. Plastic coatings, plastic inserts, or plastic dies are particularly advantageous. Rotating dies have also proven advantageous, and the upper and lower dies should be configured rotatably if possible. A plastic insert can usually be dispensed with in the case of rotating dies. In this case the die surfaces should be electropolished.

It has furthermore become apparent that long pressing times are advantageous. These can be implemented using pressing rails, multiple pressing rollers, or low rotor rotation speeds. Because fluctuations in tablet hardness can be caused by fluctuations in pressing forces, systems that limit the pressing force should be utilized. Elastic dies, pneumatic compensators, or resilient elements in the force path can be used here. The pressing roller can also be embodied resiliently.

Tableting machines that are suitable in the context of the present invention are obtainable, for example, from the following companies: Apparatebau Holzwarth GbR, Asperg; Wilhelm Fette GmbH, Schwarzenbek; Hofer GmbH, Weil; Horn & Noack Pharmatechnik GmbH, Worms; IMA Verpackungssysteme GmbH Viersen; KILIAN, Cologne; KOMAGE, Kell am See; KORSCH Pressen AG, Berlin; and Romaco GmbH, Worms. Additional suppliers are, for example, Dr. Herbert Pete, Vienna (AU); Mapag Maschinenbau AG, Bern (CH); BWI Manesty, Liverpool (GB); I. Holand Ltd., Nottingham (GB); Courtoy N.V., Halle (BE/LU); and Mediopharm Kamnik (SI). The HPF 630 hydraulic double-pressure press of the LAEIS company (D) is, for example, particularly suitable. Tableting tools are available, for example, from the following companies: Adams Tablettierwerkzeuge, Dresden; Wilhelm Fett GmbH, Schwarzenbek; Klaus Hammer, Solingen; Herber & Söhne GmbH, Hamburg; Hofer GmbH, Weil; Horn & Noack, Pharmatechnik GmbH, Worms; Ritter Pharamatechnik GmbH, Hamburg; Romaco, GmbH, Worms; and Notter Werkzeugbau, Tamm. Additional suppliers are, for example, Senss AG, Reinach (CH) and Medicopharm, Kamnik (SI).

The shaped elements can be produced in a predetermined three-dimensional shape and predetermined size. Practically all configurations that can reasonably be handled are suitable as three-dimensional shapes, i.e. for example an embodiment as slabs, a rod or bar shape, cubes, cuboids, and corresponding three-dimensional shapes having flat lateral surfaces, as well as, in particular, cylindrical configurations having a circular or oval cross section. This latter configuration encompasses the presentation form extending from a tablet to compact cylindrical pieces having a height-to-diameter ratio exceeding 1.

The portioned pressed items can be embodied respectively as individual elements that are separated from one another and correspond to the predetermined metered quantity of washing and/or cleaning agent. It is likewise possible, however, to configure pressed items that combine a plurality of such dimensioned units into one pressed item, easy separability of smaller portioned units being provided for, in particular, by predefined break points. For the use of textile washing agents in machines of the type common in Europe, having a horizontally arranged mechanism, the embodiment of the portioned pressed items as tablets or in a cylindrical or cuboidal shape can be useful, a diameter-to-height ratio in the range from approximately 0.5:2 to 2:0.5 being preferred. Commercially available hydraulic presses, eccentric presses, or rotary presses are suitable apparatuses in particular for the manufacture of such pressed items.

The three-dimensional shape of a different embodiment of the shaped element is adapted, in terms of its dimensions, to the bleach dispenser of commercially available household washing machines, so that the shaped element can be introduced directly, with no metering aid, into the bleach dispenser, where it dissolves during the first washing cycle. An introduction of the washing-agent shaped element, by way of a metering aid or even without a metering aid, directly into the washer drum is, of course, also possible without difficulty, and is preferred in the context of the present invention.

A further preferred shaped element that can be manufactured has a plate- or slab-like structure with alternatingly long thick and short thin segments, so that individual segments can be broken off from this “chocolate bar” at the defined break points constituted by the short thin segments, and introduced into the machine. This principle of the “chocolate-bar” shaped-element washing agent can also be implemented in other geometric shapes, for example vertically upright triangles that are longitudinally joined to one another on only one of their sides.

It is also possible, however, for the various components not to be compressed into a uniform tablet, but instead for shaped elements to be obtained that exhibit multiple layers, i.e. at least two layers. It is also possible in this context for these various layers to exhibit different dissolution rates. Advantageous applications-engineering properties of the shaped elements can result therefrom. For example, if the shaped elements contain components that have a negative influence on one another, it is then possible to integrate the one component into the faster-dissolving layer and incorporate the other component into a slower-dissolving layer, so that the first component has already finished reacting when the second goes into solution. The layered structure of the shaped elements can also be achieved in stacked fashion, such that a dissolution process of the inner layer(s) at the edges of the shaped element is already occurring when the outer layers are not yet completely dissolved; it is also possible, however, to achieve complete encasing of the inner layer(s) by the layer(s) respectively located farther out, which results in prevention of premature dissolution of constituents of the inner layer(s).

In a further preferred embodiment of the invention, a shaped element is made up of at least three layers, i.e. two outer and at least one inner layer, a peroxy bleaching agent being contained in at least one of the inner layers, while in the context of stacked shaped elements the two cover layers, and in the context of casing-shaped shaped elements the outermost layers, are nevertheless free of peroxy bleaching agents. It is additionally possible for peroxy bleaching agents and any bleach activators and/or enzymes that may be present to be physically separated from one another in a shaped element. Multi-layer shaped elements of this kind have the advantage they can be used not only via a bleach dispenser or by way of a metering apparatus that is introduced into the washing bath; instead, it is also possible in such cases to bring the shaped element directly into contact with the textiles in the machine with no risk of spotting as a result of bleaching agents and the like.

Similar effects can also be achieved by coating individual constituents of the washing- and cleaning-agent composition that is to be compressed, or of the entire shaped element. For this, the elements to be coated are sprayed, for example, with aqueous solutions or emulsions, or else receive a covering by way of the melt-coating method.

After compression, the washing- and cleaning-agent shaped element exhibit excellent stability. The fracture resistance of cylindrical shaped elements can be determined by way of the measured variable of the diametral fracture stress. This can be ascertained as

$$σ = \frac{2 P}{π Dt}$$

where σ denotes the diametral fracture stress (DFS) in Pa, P is the force in N that results in the pressure exerted on the shaped element that causes fracture of the shaped element, D is the shaped-element diameter in meters, and t is the height of the shaped element.

1-13. (canceled)

14. A method comprising: (a) neutralizing an anionic surfactant acid with a solid neutralization agent, wherein the anionic surfactant acid has a water content of 5 to 24 wt %, and wherein the anionic surfactant acid and the solid neutralization agent are agglomerated in a free-fall mixer, to form surfactant granules having a bulk density of 300 to 800 g/l.

15. The method according to claim 14, wherein the anionic surfactant acid has a water content of 6 to 22 wt %.

16. The method according to claim 14, wherein the anionic surfactant acid has a water content of 7 to 20 wt %.

17. The method according to claim 14, wherein the anionic surfactant acid comprises one or more substances selected from the group consisting of carboxylic acids, sulfuric acid semiesters, sulfonic acids, and mixtures thereof.

18. The method according to claim 14, wherein the anionic surfactant acid comprises a C₈₋₁₆ alkylbenzenesulfonic acid.

19. The method according to claim 16, wherein the anionic surfactant acid comprises a C₈₋₁₆ alkylbenzenesulfonic acid.

20. The method according to claim 14, wherein the surfactant granules have a neutralized anionic surfactant acid content of 50 wt % or less.

21. The method according to claim 19, wherein the surfactant granules have a neutralized anionic surfactant acid content of 50 wt % or less.

22. The method according to claim 14, wherein the anionic surfactant acid has a temperature of 20 to 60° C. at entry into the free-fall mixer.

23. The method according to claim 14, wherein the surfactant granules have a bulk density of 350 to 700 g/l.

24. The method according to claim 14, wherein the surfactant granules have a particle size distribution with an average particle size d₅₀ below 5000 μm.

25. The method according to claim 14, wherein at least 80 wt % of the surfactant granules have a particle size of 100 to 1600 μm upon exiting the free-fall mixer.

26. The method according to claim 14, wherein at least 52 wt % of the surfactant granules have a particle size of 100 to 800 μm upon exiting the free-fall mixer.

27. The method according to claim 14, wherein the surfactant granules have a particle size distribution with an average particle size d₅₀ below 5000 μm, wherein at least 80 wt % of the surfactant granules have a particle size of 100 to 1600 μm upon exiting the free-fall mixer, and wherein at least 52 wt % of the surfactant granules have a particle size of 100 to 800 μm upon exiting the free-fall mixer.

28. The method according to claim 14, wherein the free-fall mixer comprises a device selected from the group consisting of drum mixers, tumble mixers, cone mixers, double-cone mixers, V mixers and combinations thereof.

29. The method according to claim 14, wherein the agglomeration is carried out in the free-fall mixer with a residence time of less than 20 minutes.

30. The method according to claim 14, further comprising subsequent processing of the surfactant granules after discharge from the free-fall mixer.

31. The method according to claim 29, wherein the subsequent processing is carried out with a device selected from the group consisting of a pneumatic fluidized bed, a transport belt, a mixer or combinations thereof.

32. A method comprising: (a) neutralizing an anionic surfactant acid with a solid neutralization agent, wherein the anionic surfactant acid comprises one or more substances selected from the group consisting of carboxylic acids, sulfuric acid semiesters, sulfonic acids, and mixtures thereof and has a water content of 6 to 22 wt %, and wherein the anionic surfactant acid and the solid neutralization agent are agglomerated in a free-fall mixer selected from the group consisting of drum mixers, tumble mixers, cone mixers, double-cone mixers, V mixers and combinations thereof, to form surfactant granules having a bulk density of 400 to 650 g/l and a neutralized anionic surfactant acid content of 8 to 42 wt %, wherein the surfactant granules have a particle size distribution with an average particle size d₅₀ of 20 to 3000 μm, wherein at least 85 wt % of the surfactant granules have a particle size of 100 to 1600 μm upon exiting the free-fall mixer, wherein at least 70 wt % of the surfactant granules have a particle size of 100 to 800 μm upon exiting the free-fall mixer, and wherein the anionic surfactant acid has a temperature of 30 to 55° C. at entry into the free-fall mixer.

33. A method comprising: (a) neutralizing an anionic surfactant acid with a solid neutralization agent, wherein the anionic surfactant acid comprises a C₈₋₁₆ alkylbenzenesulfonic acid and has a water content of 6 to 22 wt %, and wherein the anionic surfactant acid and the solid neutralization agent are agglomerated in a free-fall mixer selected from the group consisting of drum mixers, tumble mixers, cone mixers, double-cone mixers, V mixers and combinations thereof, to form surfactant granules having a bulk density of 500 to 600 g/l and a neutralized anionic surfactant acid content of 10 to 35 wt %, wherein the surfactant granules have a particle size distribution with an average particle size d₅₀ of 40 to 2000 μm, wherein at least 95 wt % of the surfactant granules have a particle size of 100 to 1600 μm upon exiting the free-fall mixer, wherein at least 80 wt % of the surfactant granules have a particle size of 100 to 800 μm upon exiting the free-fall mixer, and wherein the anionic surfactant acid has a temperature of 40 to 50° C. at entry into the free-fall mixer.
